(19) United States
(12) Patent Application Publication
(10) Pub. No.: US 2008/0215991 A1
(43) Pub. Date: Sep. 4, 2008

(54) ADVERTISING TOOL FOR THE INTERNET

(75) Inventors: Ran Berko, Tel Aviv (IL); Yossi Oz, Rishon Lezion (IL)

Correspondence Address: EDWARD S. SHERMAN, ESQ., 3554 ROUND BARN BLVD., SUITE 303, SANTA ROSA, CA, 95403, US

(73) Assignee: NEXT-NET, LTD., Tel-Aviv (IL)

(21) Appl. No.: 11/769,968

(22) Filed: Jun. 28, 2007

Related U.S. Application Data
(60) Provisional application No. 60/806,500, filed on Jul. 3, 2006.

(51) Int. Cl. G06F 3/048

(52) U.S. Cl. 715/753; 715/764

(57) ABSTRACT

It is disclosed an improved advertising tool for attracting viewers' attention to the advertised material on the Internet. In accordance with one embodiment of the present invention the advertising tool provides an interactive banner for the purpose of displaying advertising content on web sites. The interactive banner is enabled to display a sequence of creative scenes that are dynamically changed according to an input or inputs from the user. Each of the creative scenes may be a recorded or live video stream, an audio stream, a text, a graphical image, combinations thereof, and so on. In accordance with another embodiment the disclosed advertising tool establishes a virtual meeting with a representative (e.g., a sale representative) and a viewer. The virtual meeting may be in the form of a live video stream, an audio stream, an online chat, or any combination therefore. Any communication between the representative and viewer may be encrypted.

### CROSS REFERENCE TO RELATED APPLICATIONS

This application claims the benefit of the U.S. provisional application 60/806,500, titled “Advertising tool for the Internet”, filed on Jul. 3, 2007, 2006, which is incorporated by reference in its entirety.

### BACKGROUND OF INVENTION

The present invention relates generally to advertising over the Internet, and more particularly improved advertising tools for attracting viewers' attention to the advertised material on the Internet.

Interactive forms of media, such as provided on the Internet, have become widespread. Initially, the major advertising form on the Internet was based on banner advertising, which generally promotes a specific vendible product. When the banner is clicked upon, the user is linked to the advertiser's site, where more detailed information is provided about the products or services. Fundamentally, the banner advertisement competes for the viewers' attention with the other material provided on the site. Unfortunately, banner advertisements have proven to be unreliable as means of attracting the consumers' attention. Specifically, the correlation between the number of banner hits and an increase in sales of the promoted products or services is relatively low.

In order to solve the problem of low user interest in special offerings, prior art solutions suggest advertising forms that include pop-up, pop-under, and fly over banners (or ads). However, these forms are considered very intrusive, annoying to the user and distracting, as far as the on-going and generally main browsing activity is concerned. As a result, online ad-blocking software has been developed. This software can prevent many types of banners from being displayed to a user.

In addition to the annoyance factor of banners, such advertising means are no longer effective in attracting the user to interact with the displayed content. Specifically, banners merely present content (either static or dynamic) to the user, but they do not provide any level of interaction with user other than the linking to another web page. As a result, banners in the form that is familiar today, causes many people to generally ignore the products or services offered.

Therefore, there is a need for an improved advertising tool on the Internet that can attract viewers' attention to the advertised material.

### SUMMARY OF INVENTION

In one embodiment of an improved advertising tool for attracting viewers' attention to the advertised material on the Internet, an interactive banner is displayed on the Internet user's screen, the banner displaying a sequence of creative scenes that are dynamically changed responsive of an input or inputs from the viewer.

In another embodiment of the invention, the improved tool generates a virtual meeting between a sale representative and the viewers over the Internet. Such a virtual meeting may be established over the Internet by means of at least one of a live video stream, an audio stream, and an on-line chat. Preferably, such communication established by the advertising tool between the sale representative and the viewer is encrypted.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is exemplary illustration of a network system operative in accordance with the present invention;

FIGS. 2A and 2B are a series of exemplary screenshots illustrating the disclosed interactive banner in one embodiment of the present invention;

FIG. 3 is a flowchart describing the method for activating the interactive banner in accordance with an exemplary embodiment of this invention;

FIGS. 4A and 4B are a series of exemplary screenshots illustrating the disclosed virtual meeting in one embodiment of the present invention.

### DETAILED DESCRIPTION

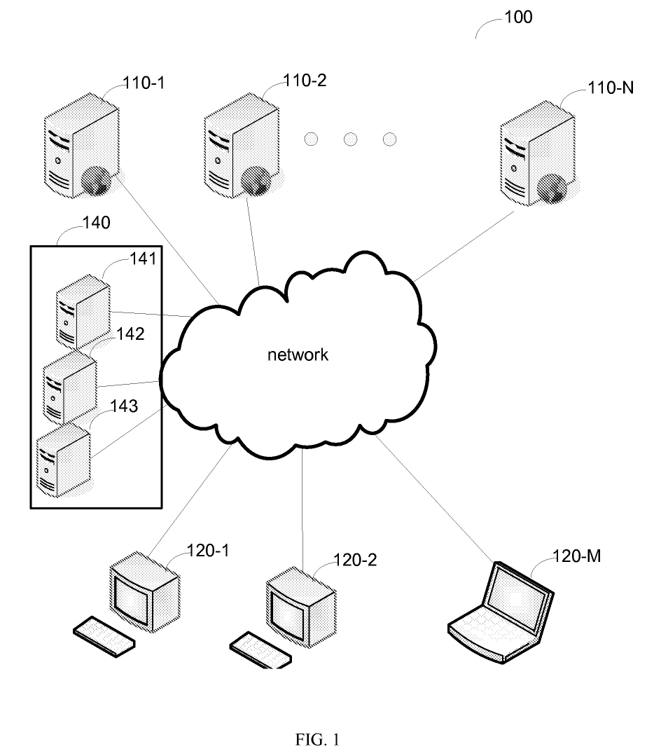

Referring to FIGS. 1 through 4, wherein like reference numerals refer to like components in the various views, there is illustrated therein a new and improved advertising tool for the internet, deployed on a network system denominated 100 herein.

The present invention discloses an advertising system and method for attracting viewers' attention to the advertised material on the Internet. Specifically, the advertising system and method provide an interactive banner which draws the viewer's attention to the displayed content. The interactive banner displays a sequence of creative scenes that are dynamically changed responsive of an input or inputs from the viewer (or user). Firstly, an opening scene is presented where the user is invited to click the banner or to select one of many given options. If the viewer chooses to get more information on the offered product or service, a multiple choice question is presented. Each time that the viewer selects an answer another multiple-choice question is displayed, until the aim of the banner is achieved. As will be described in detail below, if the viewer has not clicked the banner or answered one of the questions a new scene is displayed to encourage him to perform either one of these actions.

FIG. 1 shows an exemplary illustration of a network system 100, operative in accordance with the present invention. Network system 100 includes a plurality of servers 110 and clients 120 that communicate through a network 130, for example, a wide area network (WAN) that enables connectivity such as Internet connectivity, and further includes at least one advertising system 140. A client 120 comprises a pointing device, such as a mouse and a web browser, such as Microsoft Internet Explorer allowing the user to view, navigate, and generally interact with web pages downloaded from one or more servers 110. Each client 120 is capable of executing the improved advertising tool using the methods disclosed herein. The methods are executed over a client 120 and described in greater detail below.

Advertising system 140 is coupled to network 130 and is capable of at least receiving an input from a client 120 and accordingly changing the interactive content displayed in the interactive banner. The interactive content is a sequence of creative scenes, where each scene may be, but is not limited to, an image, a video clip, a text description, another web page, a live broadcasted content, search results retrieved from a search engine, any combination thereof, and so on. As will be discussed in detail below, the interactive content is individually changed for each client 120. That is, for each client, according to the user characteristic and the level of interactivity, advertising system 140 uploads different adverting material.

In accordance with the present invention, advertising system 140 includes three servers: a content server 141, an application server 142, and a scheme server 143. Content server 141 sends that interactive content to clients 120. Application server 142 manages the interaction with each client 120, i.e., application server 142 gets the inputs from a client 120 and based on the inputs determine the next scene to be displayed. Furthermore, on each client 120, application server 142 collects information about the scenes and advertising campaigns that displayed on each client. Server 142 also collects information about inputs received from each client in each scene. This allows, when establishing a new session with a web-site, to continue the interaction with user from the last displayed scene; or otherwise to upload new campaign if the user has shown not interest in the previously displayed content. Scheme server 143 includes campaign's schemes, each of which define the sequence of scenes to be display in responsive to the user input.

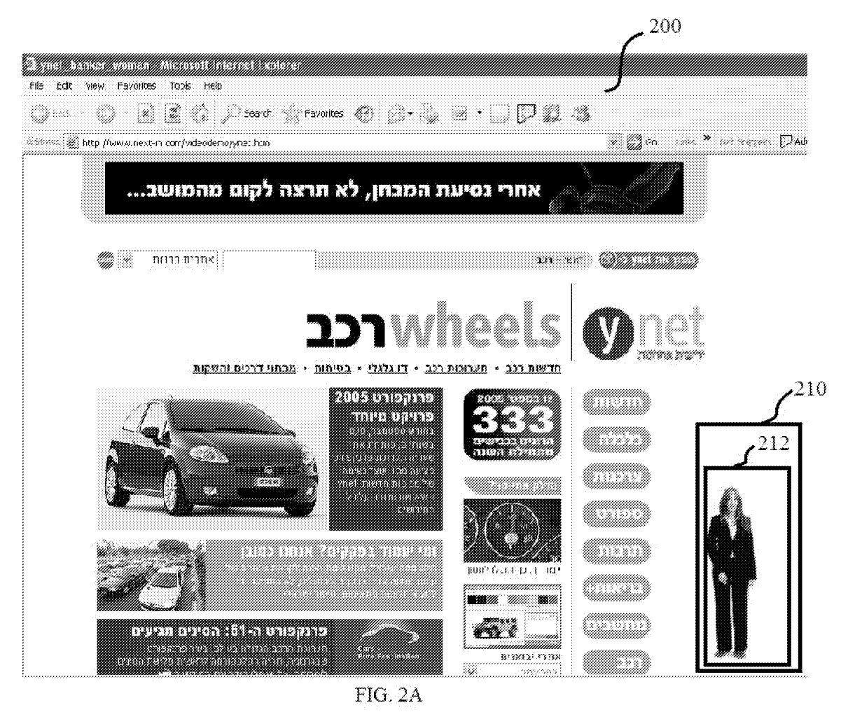

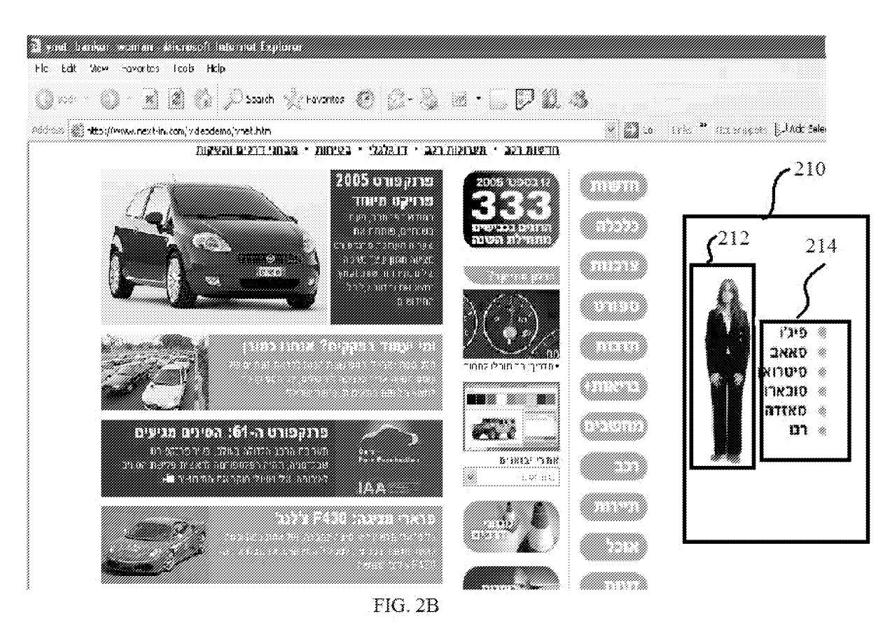

FIG. 2 shows a series of exemplary and non-limiting screenshots illustrating the interactive banner. FIG. 2A provides an exemplary web page 200 downloaded from one of servers 110 and displayed over client's 120 web browser. As illustrated in FIG. 2A, an interactive banner 210 is presented on a portion of web page 200. The size of the interactive banner 210 and its location are configurable parameters. That is, banner 210 can be positioned anywhere on the web page 200.

At the opening scene a character, shown in a display section 212, invites the viewer to scroll over the interactive banner 210. For example, character sounds out “looking for a new car, I will be happy to help you . . . ”. In the next scene, once the viewer crosses over banner 210 with, for example, a pointing device, a multiple-choice question is displayed, and the user is prompted to select one of options in an input section 214. As illustrated in FIG. 2B the viewer is asked to select a type of a car that he or she wishes to buy. At such an event, character sounds out “please select the requested car type from the list . . . ”. Upon selecting one of options, the user may be directed to a web site of the car dealer so as to get more information.

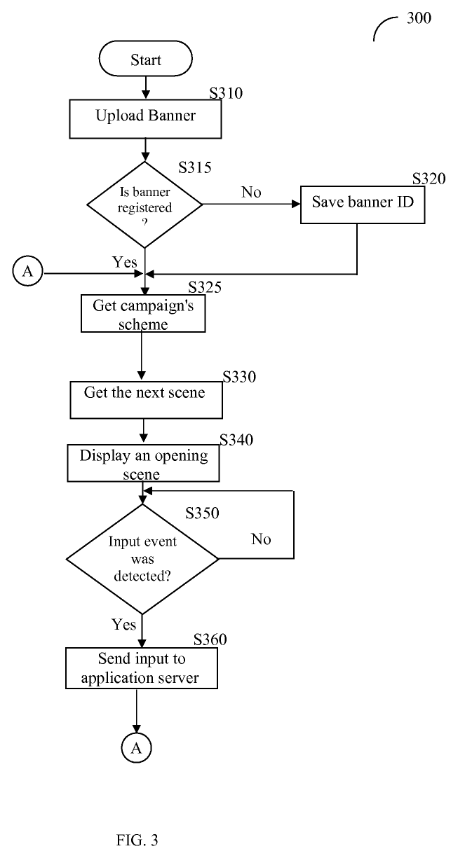

FIG. 3 shows a non-limiting and exemplary flowchart 300 describing the method for activating the interactive banner, in accordance with an embodiment of the present invention. The method is executed over a client 120 that communicates with advertising system 140 through network 130. Prior to execution, one or more configurable setting parameters are set to their initial values. These parameters comprise at least the duration of waiting time, the size of the interactive banner, the banner's location on the web page, and so on. The setting parameters may be configured by an advertisement agency previous to releasing an ad-campaign.

Once a user browses to a web page configured to display the interactive banner, at S310, the interactive banner is loaded on the web page. Each interactive banner uploaded to a client 120 has a unique identification (ID) number. At S315, the banner checks its registration in the client. Specifically, the banner checks if its ID is included in a Local Shared Object directory in client 120. If so, execution continues with S325; otherwise, at S320, the banner's ID is saved in client 120. At S325 the campaign scheme is received from scheme server 143, and thereafter at S330, a scene to be displayed is retrieved from content server 141. If the banner was previously displayed on client 120 (i.e., S315 results with “No” answer, the next scene is retrieved according to inputs received from the user during the last time he or she interacted with the banner and further according to the campaign scheme. If it is the first time that the banner is uploaded to the client (i.e., step S315 results with “Yes” answer) the opening scene of the campaign is retrieved from content server 141.

At S340, the content of the scene to be displayed is sent from content server 141 and played in the interactive banner. At S350, the position of the cursor is constantly monitored to determine if the user moves the cursor over the interactive banner and/or selects one of the options. Execution waits at S350 until such an event is detected or until the waiting time period has elapsed, whichever occurs first. Once an input event is triggered execution proceeds to S350. The input trigger may be, for example, an interaction with the banner, a user selection, or no response after a predefined amount of time, and so on. At S360, the user's input is sent to application server 142. Execution returns to S330 where the interactive content of the next scene is retrieved from content server 141 according to the user's input and the campaign scheme. This ensures that two consecutive scenes always communicate different messages to the user and that messages presented by those scenes follow a specific flow. For example, the first opening scenes may play the message “looking for a new car, I will be happy to help you . . . ”. If the user did not click the banner for the duration of the waiting time, then the following opening scene may inspire him to do so by playing the message “excuse me, I'm still waiting, click and get a discount . . . ” and played in the interactive banner. Execution ends whenever the user chooses to close the interactive banner or browse to another web page.

The advertising system 140 includes, for each client 120 or group of clients, a sequence of creative scenes (a stake) to be displayed in the interactive banner. Advertising system 140 may include multiple stacks each associated with multiple interactive display areas in a single interactive banner. Advertising system 140 may further include multiple stacks each associated with a single interactive display area in a single interactive banner. This can be used, for example, to show different creative scenes in different times (e.g., days or hours). Advertising system 140 maintains an exposure table utilizes for recording at least the times where each user views and interacts with the interactive banner and the user's selections. In another embodiment of the present invention advertising system 140 generates statistical reports regarding the viewers' exposure to interactive banners. Specifically, for each web site (that displays the banner) a report includes the actual number of users that entered the site. The report also contains, for each user, the duration, dates and times that a user watched the banner. The statistical reports can be utilized by an advertising agency to determine if an ad-campaign was successful and further to examine ways to improve current or future ad-campaigns using the exposure data.

The system 140 is further capable to monitor and alert the campaign manager on scenes that do not attract the viewer attention. The campaign manager can change the scenes and the scene's sequence in real time based on that input.

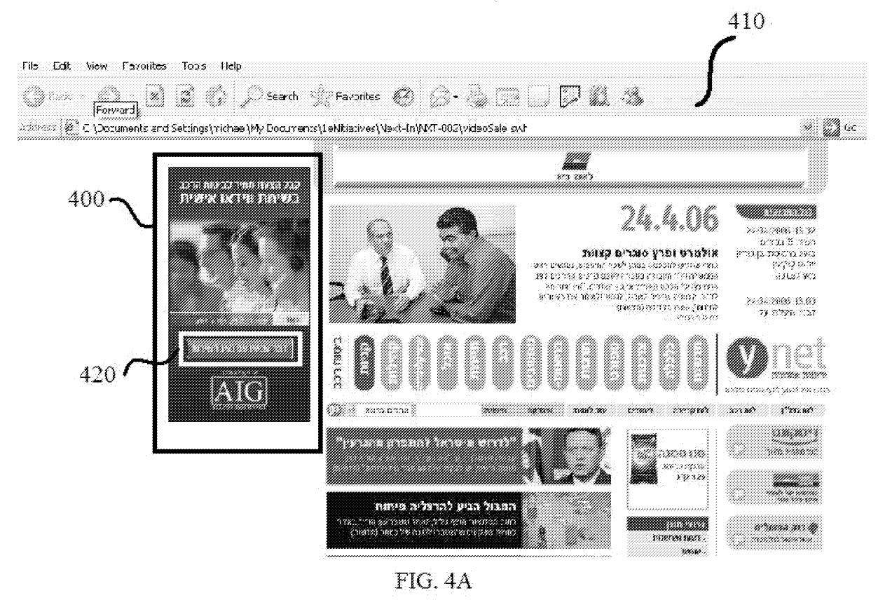

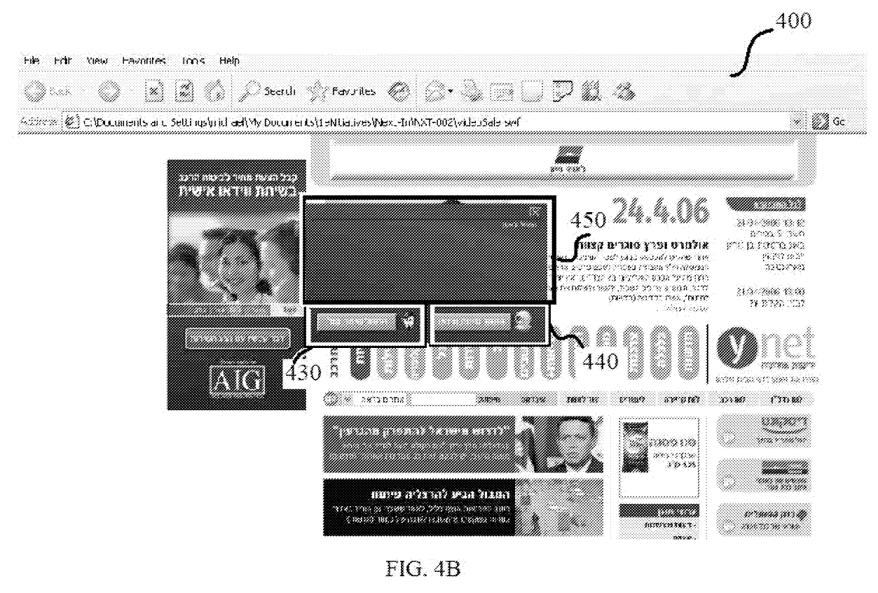

In accordance with another embodiment of the present invention the improved advertising system 140 is capable of establishing a virtual meeting between a representative (e.g., a sale representative, a support representative, etc.) and the viewer. This allows them to communicate through, for example, a live video, VOIP, a chat, combination thereof, and the like. Namely, the viewer may watch the representative over his display and on-line chat with her. Furthermore, the representative can view the content currently displayed over the viewer's browser. The activation of the virtual meeting can be done from an interactive banner or by clicking on a button displayed on a web-site. FIG. 4 shows a series of exemplary and non-limiting screenshots illustrating the interactive banner. FIG. 4A provides a web page 400 downloaded from one of servers 110 and displayed over client's 120 web browser. As illustrated in FIG. 4A, an ad 410 that includes a button 420 invites the viewer to activate the virtual meeting feature. As depicted in FIG. 4B, upon clicking button 420 the viewer selects the communication form, i.e., by live video (by clicking button 430), audio (clicking button 440) or an on-line chat (by typing the message in the display area 450).

The inventors have noted that in some embodiments any content exchanged between the representative and the viewer is encrypted regardless to the communication form selected by the viewer. The encryption can be achieved by means of encryption techniques including, but not limited to, a secure sockets layer (SSL) protocol, a secure HTTP (S-HTTP), an advanced encryption standard (AES), and the like.

It would be appreciated by a person skilled in the art that virtual meeting feature described herein is highly effective in financial web sites (e.g., banks or insurance companies' sites). For example, the virtual meeting feature may allow support personnel to instruct novice viewers to perform financial actions through a bank's web site while all actions and the discussions are encrypted.

It should be noted that various modifications, combinations, sub-combinations and alterations of the above-described embodiments may occur, as required, insofar as they are within the scope of the appended claims or the equivalents thereof.

The principles of the present invention may be implemented as in hardware, software firmware or a combination thereof. The software may be implemented as an application program tangibly embodied on a program storage unit or computer readable medium. The application program may be uploaded to, and executed by, a machine comprising any suitable architecture, for example a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention. All examples and conditional language recited herein are intended for pedagogical purposes to aid the reader in understanding the principles of the invention and the concepts contributed by the inventors to furthering the art, and are to be construed as being without limitation to such specifically recited examples and conditions.

All statements herein reciting principles, aspects, and embodiments of the invention, as well as specific examples thereof, are intended to encompass both structural and functional equivalents thereof. It is intended that such equivalents include both currently known equivalents as well as equivalents developed in the future, i.e., any elements developed that perform the same function, regardless of structure. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicants thus regards any means that can provide those functionalities as equivalent to those shown herein.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A web page having an interactive banner which comprises:
a) a display section for displaying advertising content through a sequence of scenes; and
b) an input section through which a viewer interacts with the advertising content, wherein a current scene to be displayed in the display section is determined according to the viewer's input and a campaign scheme.

2. The web page of claim 1, wherein the advertising content is of one or more forms selected from the group consisting of: a video stream, an audio stream, a text and a graphical image.

3. The web page of claim 2, wherein the advertising content in the interactive banner is sent from an advertising system and displayed on a web-page using a web browser.

4. The web page of claim 3, wherein the interactive banner is displayed on a portion of the web page.

5. A method for displaying advertising content in an interactive banner on a web browser of a client, comprising:
a) downloading the interactive banner from an advertising system to a web browser of a client;
b) retrieving the first scene to be displayed in the interactive banner from the advertising system;
c) playing the scene in the interactive banner; and
d) changing the scene displayed in the interactive banner according to a viewer's input and a campaign scheme.

6. The method of claim 5, further comprising the step of registering the interactive banner in the client.

7. The method of claim 6, wherein said step of registering the interactive banner comprises saving a unique identification (ID) number of the interactive banner in a Local-shared-object directory.

8. The method of claim 7, wherein the first scene to be displayed is determined according to a previous state of the interactive banner.

9. The method of claim 7, wherein the scenes include the advertising content.

10. The method of claim 9, wherein one or more forms of advertising content accessible through the interactive banner is selected from the group consisting of a video stream, an audio stream, a text, and a graphical image.

11. The method of claim 5, wherein the campaign scene determines the next scene based on the viewer's input.

12. The method of claim 5, further comprising the step of saving the viewer's input received in each displayed scene.

13. The method of claim 5, wherein the interactive banner is displayed on a portion of the web page.

14. A computer program product including a computer-readable medium comprising software instructions operable to enable a computer to perform a method for displaying advertising content in an interactive banner on a web browser of a client, wherein the instructions are operative to:
a) download the interactive banner from an advertising system to a web browser of a client;
b) retrieve the first scene to be displayed in the interactive banner from the advertising system;
c) play the scene in the interactive banner; and
d) change the scene displayed in the interactive banner according to a viewer's input and a campaign scheme.

15. The computer program product of claim 14, wherein the software instructions are further operable to register the interactive banner in the client.

16. The computer program product of claim 15, wherein when the software instructions are further operable to register interactive banner comprising a unique identification (ID) number of the interactive banner is saved in a Local-shared-object directory.

17. The computer program product of claim 16, wherein when the software instructions are operable to display a first scene according to a previous state of the interactive banner.

18. The computer program product of claim 16, wherein at least one of the scenes displayed includes advertising content.

19. The computer program product of claim 20, wherein the advertising content is in at least one form from the group consisting of a video stream, an audio stream, a text, and a graphical image.

20. The computer program product of claim 14, wherein the campaign scene determines the next scene based on the viewer's input.

21. The computer program product of claim 14, wherein the software instructions are operable to save the viewer's input received in each displayed scene.

22. The computer program product of claim 14, wherein the software instructions are operable to display the interactive banner on a portion of the web page.

23. An advertising transmission system for generating an interactive banner to be displayed on a web browser of a client, comprises:
a) a content server for providing advertising content to be displayed in the interactive banner through a sequence of scenes;
b) an application server for managing the scene based on inputs received from the viewers; and
c) a scheme server for providing campaign scheme to interactive banner.

24. The advertising transmission system of claim 23, wherein the application server is further capable of:
a) collecting information about inputs received from each client in each scene; and
b) managing information about scenes and campaigns displayed in each client.

25. The advertising transmission system of claim 24, wherein advertising content is transmitted in one or more forms selected from the group consisting of a video stream, an audio stream, a text, and a graphical image.

26. The advertising transmission system of claim 23 that is further capable of:
a) establishing a virtual meeting between a representative and viewers over the Internet.

27. The advertising transmission system of claim 26, wherein the virtual meeting is established over the Internet by means of at least one of: a live video stream, an audio stream, and an on-line chat.

28. The advertising transmission system of claim 27, where the communication between the representative and the viewers is encrypted.
